(19) United States
(12) Patent Application Publication
(10) Pub. No.: US 2009/0019963 A1
(43) Pub. Date: Jan. 22, 2009

(54) STEERING COLUMN FOR MOTOR VEHICLE

(76) Inventors: Robert Walter Hubrecht, Haag (CH); Thorsten Hornich, Mauren (AT)

Correspondence Address: WENDEROTH, LIND & PONACK, L.L.P., 2033 K STREET N. W., SUITE 800, WASHINGTON, DC, 20006-1021, US

(21) Appl. No.: 12/099,104

(22) Filed: Apr. 7, 2008

Related U.S. Application Data
(63) Continuation of application No. PCT/EP2006/009372, filed on Sep. 27, 2006.

(30) Foreign Application Priority Data
Oct. 5, 2005 (DE) 10 2005 047 789.5

(51) Int. Cl. B62D 1/18

(52) U.S. Cl. 74/493

(57) ABSTRACT

A steering column for a motor vehicle comprises: a rotationally mounted steering spindle (2); a jacket unit (3), which rotationally mounts a section of the steering spindle (2); a supporting unit (4), which can be connected to the chassis of the motor vehicle, and in relation thereto the jacket unit (3) can be displaced in at least one direction of displacement, and; a tightening mechanism (6) that, when closed, the position of the steering column is fixed and the jacket unit (3) is braced with the supporting unit (4), the tensioning mechanism comprising a draw bolt (9) that, via openings (10, 11), passes through the jacket unit (3) and the supporting unit (4) transversal to the axis of the steering spindle (2), and; first and second tensioning elements (16, 17) between which roll bodies (27) are arranged for reducing friction during mutual twisting. The first tensioning element (16) is forced into its closed position by a tension spring (21). When an actuating force acting upon the actuation element (24) is terminated, the first tensioning element (16) turns from its open position into its closed position. Denticulations (7, 8) serve to fix the displacement of the steering column in at least one direction of displacement.

This is a Rule 1.53(b) Continuation of International Application No. PCT/EP2006/009372, filed Sep. 27, 2006.

### BACKGROUND OF THE INVENTION

a) Field of the Invention

The invention relates to a steering column for a motor vehicle, which is displaceable in at least one adjustment direction, comprising a pivotably bearing-supported steering spindle, a jacket unit which pivotably bearing-supports a section of the steering spindle, a support unit connectable to the chassis of the motor vehicle and with respect to which the jacket unit is displaceable in the at least one adjustment direction, and a clamping mechanism, in the opened state of which the position of the steering column is adjustable and in the closed state of which the position of the steering column is secured in position and the jacket unit is clamped with the support unit, wherein the clamping mechanism comprises a clamp bolt penetrating through openings of the jacket unit and the support unit transversely to the axis of the steering spindle, and first and second clamp members disposed on the clamp bolt, of which the first clamp member is turnable for opening and closing the clamp mechanism with respect to the second clamp member between an open position and a closed position about the axis of the clamp bolt or about an axis at right angles to the axis of the clamp bolt and between which roller bearings are disposed for the friction reduction during the mutual turning.

b) Description of Related Prior Art

Adjustable steering columns serve for the adaptation of the position of the steering wheel to the seating position of the driver. The significance of a position of the steering wheel matched to the requirements of the driver must not be underestimated. If the positioning is unfavorable, the driver is unable to concentrate fully on the traffic and becomes fatigued more quickly, which comes to bear especially during relatively long drives. The subjective steering sense can also be negatively affected, which can lead to driving errors in critical borderline situations. Precisely in the event of frequently changing drivers, good operability of the setting of the steering column position is therefore important.

The fixing device for fixing the set position in adjustable steering columns should provide in its closed state fixing forces which are as high as possible in order for the unintentional dislocation of the steering column to be prevented, for example, if the driver leans on the steering wheel while driving, uncontrolled dislocation of the position of the steering wheel cannot occur. At the same time, the fixing device should be smooth in operation and it should be possible to open and close the actuation elements with short strokes and it should assume small overall space. In particular in the closed state of the fixing device, furthermore, vibrations of parts of the steering column caused by vibrations of the motor vehicle should as much as possible be excluded.

Adjustable steering columns in which the set position is fixed by means of a clamping mechanism, wherein the clamping mechanism holds in engagement with one another securement elements cooperating under frictional and/or positive locking, are disclosed for example in EP 0 802 104 B1 or EP 0 836 981 B1. In the closed state of the clamping mechanism in the adjustable steering column of EP 0 802 104 B1, (lamella) disk packs are tightened with one another, of which one is disposed on the jacket unit and the other on the support unit. In the device of EP 0 836 981 B1 in the closed state of the clamping mechanism toothings are brought into engagement with one another, which block the dislocation of the steering column. In the steering column of EP 0 802 104 B1 as well as also in the steering column of EP 0 836 981 B1 the clamping mechanism tightens the jacket unit with the support unit, whereby inter alia also good vibration behavior is attained.

If fixing the adjustment of the steering column under positive locking, the cooperating toothings must be laid out correspondingly robust and an adequate clamping force must be provided so that the toothings cannot be brought out of engagement under a force acting onto the steering column. Therewith the paths and forces for the actuation of the actuation lever become greater. With holding under frictional locking by means of a larger number of disk packs, a relatively large opening path is required in order to space the disk packs sufficiently far apart and to permit smoothly-operating adjustment. In addition, a correspondingly high clamping force is required.

WO 2004/069629 A1 and U.S. Pat. No. 5,377,555 A furthermore disclose disposing between the two clamp members, which can be turned with respect to one another, of the clamping mechanism rolling bodies in order to replace the sliding friction by a rolling friction. While therewith the actuation force is reduced, however, the necessary clamping force for the secure closing of the clamping mechanism must, nevertheless, be applied. The necessary force is only reduced by the difference between sliding and rolling friction. It must further be ensured that the actuation lever does not change self-actingly its particular set final position in particular in the final position in which the clamping mechanism is closed. Otherwise the clamping mechanism could open self-actingly during driving and the steering column could therewith change its position. For this purpose it is known, for example, to implement the tracks of the two clamping members in the region of the closed final position of the actuation lever such that they have longer sections via which upon a mutual turning of the two clamping members no change of the clamping force occurs. However, this has the disadvantage that the actuation lever must be actuated over a correspondingly large range with a relatively high force until its closed final position has been reached. The operator, furthermore, does not receive any confirmation, for example in the form of a snapping-in, that the closed position has been reached.

In the device of U.S. Pat. No. 5,377,555 A therefore the raceways of the rolling bodies are subsequently formed on a ramp-like rise with a small drop, such that in the closed position of the clamping members a snapping-in occurs. However, this results in a weakening of the stress in the closed state of the clamping mechanism. A sudden weakening of the force to be expended frequently leads to the irritation of the driver such that the driver opens and closes the clamping mechanism again and herein must readjust the position of the steering wheel.

The operating procedure of the described devices is awkward. When opening the clamping mechanism, the driver must move the hand from the steering wheel, grasp the actuation lever located behind the steering wheel and shift it. Only then can the driver position the steering wheel into the specified setting directions. After the steering wheel has been positioned correctly, for the closing of the clamping mechanism he must proceed in the same manner as for the opening, needing to hold the steering wheel with one hand in the desired position. To hold the position in the desired position until the final closing of the clamping mechanism proves to be difficult. For every small fine correction the same procedure must be completed which always entails the same problem. In addition, adjustment of the steering column while driving is virtually impossible.

It is furthermore known to block the deviating of a jacket unit with respect to a support unit into different swivel positions thereby that a pin guided displaceably on the support in the axial direction is inserted into one of several snap recesses disposed on a portion of the jacket unit. To swivel the jacket unit, the pin is pulled out of the snap recess in which it is engaged against the force of a spring. After setting the desired swivel position of the jacket unit, the pin is released whereby it is again pulled by the spring into one of the snap recesses. While the adjustment of such steering columns is simple and practical, these steering columns, however, have a poorer vibration behavior since no clamping mechanism is available which, in the fixed state of the steering column, clamps the jacket unit with the support unit. Such steering columns are also referred to as “head tilt” steering columns.

A steering column with a similar fixing device is also disclosed in WO 2004/051807 A2. Here two mutually swivellable sections of the jacket unit are connected via a piston-cylinder unit. Several mechanisms are shown in order to fix the piston rod with respect to the cylinder in the set position of the steering column.

Furthermore, DE 3914608 C1 describes fixing the length adjustment of a steering column by means of a toothed engaging pawl. The jacket unit rotatably supporting the steering spindle includes an outer toothing extending in the longitudinal direction of the steering column, with which for blocking the longitudinal displacement an engaging pawl can come into engagement. In the fixed state of the steering column the engaging pawl is pressed by a wedge body into the toothing of the jacket unit. To open the steering column, the wedge body is pushed linearly against the force of a spring and as a consequence releases the engaging pawl.

EP 1 188 639 B1 further discloses an adjustable steering column, in which, for securing in position the set position of the steering column, outer and inner clamp jaws are provided, between which lamella plates are disposed to be clamped with one another. For this purpose the inner clamp jaws are pressed outwardly by means of cams, which here are swivellably supported on a linearly displaceable cam body. To adjust the steering column, the cam carrier is linearly shifted against the force of a spring whereby the cams are swivelled and the inner clamp jaws are shifted inwardly releasing the clamped plates. Of disadvantage in this device is the relatively complicated construction with the linearly displaceable cam carrier and the cams swivellably disposed thereon and the clamp jaws cooperating with them, which entails a comparatively large overall height leading to a restriction of the foot space. Furthermore, in this construction no optimal vibration behavior is attained in the state of the steering column after it has been secured in position.

The telescopable steering column disclosed in DE 3241575 A for securing in position the set position comprises an arrest member which is shiftable in the longitudinal direction of the steering column by means of a rotatable arrest rod. The arrest rod is rotated by a lever which, starting from an arrest position is swivellable against the force of a spring into a release position. The force expendable to secure in position the steering column is relatively low in such a design.

In the adjustable steering column of US 2005/0127656 A1 the swivel position of the steering column is held under positive locking by means of toothings, while the length adjustment is held under frictional locking at another position through a clamping mechanism. This clamping mechanism comprises a clamp bolt and clamp members disposed on the clamp bolt, which can be spread apart by means of a cam. Opening and closing takes place by means of a lever which acts onto a lever actuating the cam via a pressure rod. Opening the securement device takes place against the force of a spring. The construction disclosed in this document is complicated and optimal vibration behavior in the secured state of the steering column can here also not be attained.

### PROBLEM ADDRESSED BY THE INVENTION AND SUMMARY OF THE INVENTION

The invention addresses the problem of providing an improved steering column of the type described above, which is highly convenient and easily operated and permits the precise positioning of the steering wheel with respect to the driver.

This problem is solved according to the invention through a steering column for a motor vehicle, which is at least adjustable in one adjustment direction, comprising

a rotatably supported steering spindle,

a jacket unit which rotatably supports a section of the steering spindle,

a clamping mechanism in the opened state of which the position of the steering column is adjustable and in the closed state of which the position of the steering column is secured in position and the jacket unit is clamped with the support unit and which comprises a clamp bolt, penetrating the jacket unit and the support unit transversely to the axis of the steering spindle through openings, and first and second clamp members disposed on the clamp bolt, of which the first clamp member for opening and closing the clamping mechanism is turnable with respect to the second clamp member between an open position and a closed position about the axis of the clamp bolt or about an axis at right angles to the axis of the clamp bolt and between which rolling bodies are disposed for the friction reduction during the mutual turning,

wherein the first clamp member is acted upon into its closed position by a tension spring and through an actuation force exerted onto an actuation element is turnable against the force of the tension spring from its closed position into its open position and the tension spring upon termination of the actuation force acting onto the actuation element turns the first clamp member from its open position into its closed position and wherein for the securement in position of the adjustment of the steering column in at least one adjustment direction a toothing of a part disposed on the clamp bolt in the closed state of the clamping mechanism engages into a toothing disposed on a side shank of the support unit or on a toothed plate disposed on the side shank of the support unit.

For setting the position of the steering column in a steering column according to the invention the first clamp member is turned against the force of the tension spring into its open position, for example by means of an actuation lever disposed on the first clamp member. After the desired adjustment of the steering column, the clamp member can simply be released whereupon the arresting is brought about self-actingly by means of the tension spring. Herein also the clamping of the jacket unit with the support unit through the clamping mechanism occurs such that for the driver no play of the set position of the steering column is perceptible and vibrations of the jacket unit with respect to the support unit can be avoided. Through the rolling bodies disposed between the clamp members the friction is highly reduced such that the self-acting closing of the clamping mechanism is made possible through a tension spring with a non-excessive spring force, which must be overcome during the opening of the clamping mechanism.

In the closed state of the clamping mechanism for the securement in position of the setting of the steering column in at least one adjustment direction, a toothing of a part disposed on the clamp bolt engages into a toothing which is disposed on a side shank of the support unit or on a toothed plate disposed on the side shank of the support unit. These toothings are pressed together by the tension spring.

An advantageous embodiment of the invention provides that the support unit has side shanks between which the jacket unit is disposed and which, in the closed state of the clamping mechanism, are pressed by the tension spring onto the jacket unit on both sides. The press-on force is consequently transferred at least for one of the side shanks via the pressed-together toothings.

In an advantageous embodiment of the invention the actuation force turning the first clamp member into its open position is transferred via a Bowden cable. The actuation element for opening the clamping mechanism can thereby be disposed on a site easily accessible for the driver. For example, the actuation element can be so disposed that the driver can leave both hands on the steering wheel and can operate the actuation elements with the fingers of one hand. An appropriate force transmission system can herein be provided between the actuation force exerted onto the actuation element and the opening force acting onto the first clamp member.

A steering column according to the invention can be implemented such that it is adjustable in inclination or height and/or length. In an advantageous embodiment of the invention the steering column includes at least adjustability in inclination or height.

The securement in position of the adjustment preferably takes place in every adjustment direction in which the steering column is adjustable by means of meshing toothings which are pressed together by the tension spring in the closed state of the clamping mechanism. It is preferred that these toothings extend in planes which are transversely, in particular at right angles, to the axis of the clamp bolt.

Further advantages and details of the invention will be explained in the following in conjunction with the enclosed drawing.

### BRIEF DESCRIPTION OF THE DRAWING

The drawings depict:

FIG. 1 an oblique view of the section adjoining the steering wheel of a steering column according to the invention, in the closed state of the clamping mechanism,

FIG. 2 the steering column of FIG. 1 in the opened state of the clamping mechanism,

FIG. 3 an oblique view of the clamping mechanism and of the securement elements for the inclination adjustment in the closed state of the clamping mechanism,

FIG. 4 the parts of FIG. 3 in the opened state of the clamping mechanism,

FIG. 5 the parts of FIG. 3 without the Bowden cable and the actuation element in an exploded representation,

FIG. 6 and FIG. 7 the two closure members and the interspaced rolling bodies supported in a cage, in oblique views from different viewing angles,

FIG. 8 a vertical section through the parts (closed state of clamping mechanism) shown in FIG. 3,

FIG. 9 a vertical section through the parts (opened state of the clamping mechanism) shown in FIG. 4,

FIG. 10 a top view onto the steering column (without steering wheel),

FIG. 11 and FIG. 12 side views of the steering column (without steering wheel) in the opened and closed state of the clamping mechanism,

FIG. 13 an oblique view of a section adjoining the steering wheel of a steering column according to the invention, according to a second embodiment of the invention,

FIG. 14 a side view of the clamping mechanism and the securement elements for the height adjustment according to the second embodiment,

FIG. 15 a section along line A-A of FIG. 14,

FIG. 16 the parts of FIG. 14 in an exploded representation,

FIGS. 17 and 18 a schematic side view and top view of a steering column according to a further embodiment of the invention,

FIG. 19 an exploded representation of parts of the clamping mechanism in oblique view,

FIG. 20 an oblique view of the second clamping member comprising the toothing from a viewing angle different from that of FIG. 19.

### DESCRIPTION OF THE PREFERRED EMBODIMENT EXAMPLES

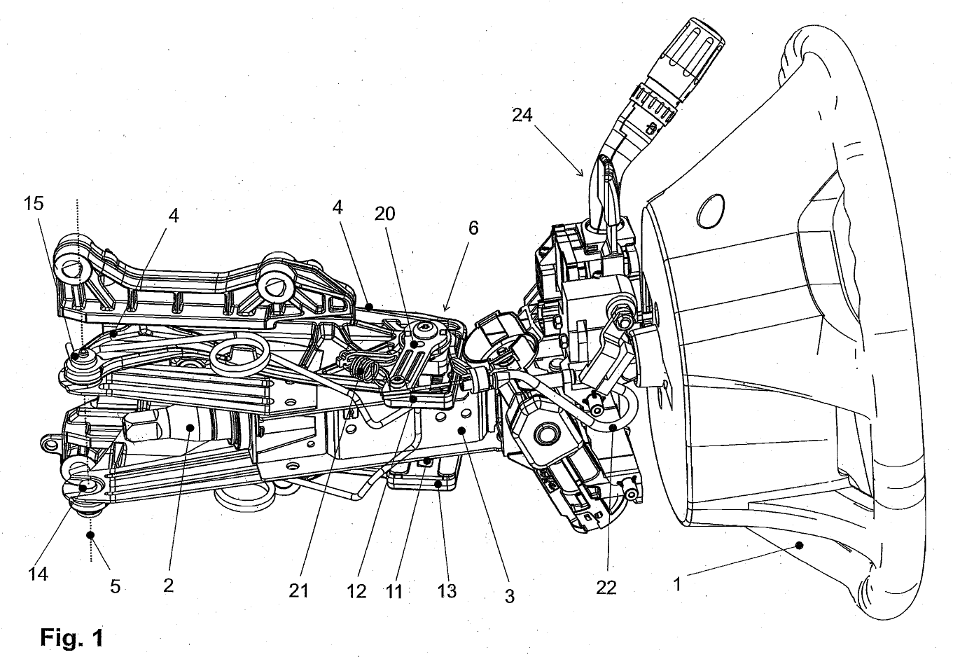

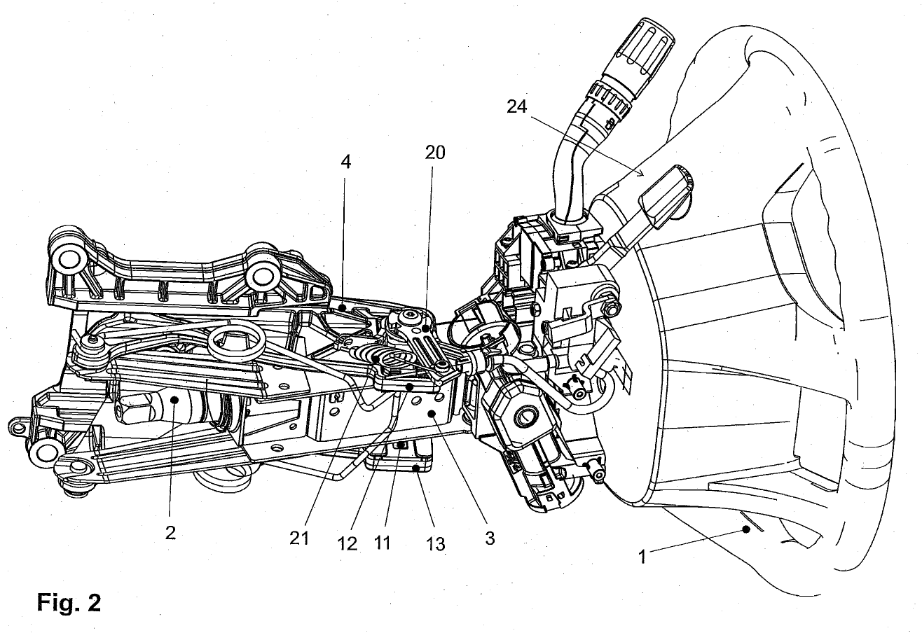

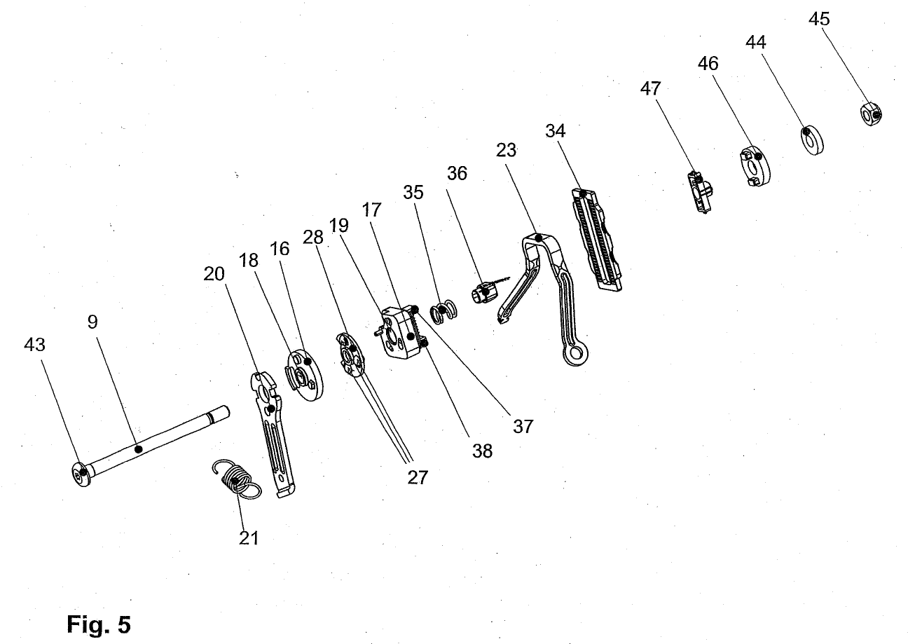

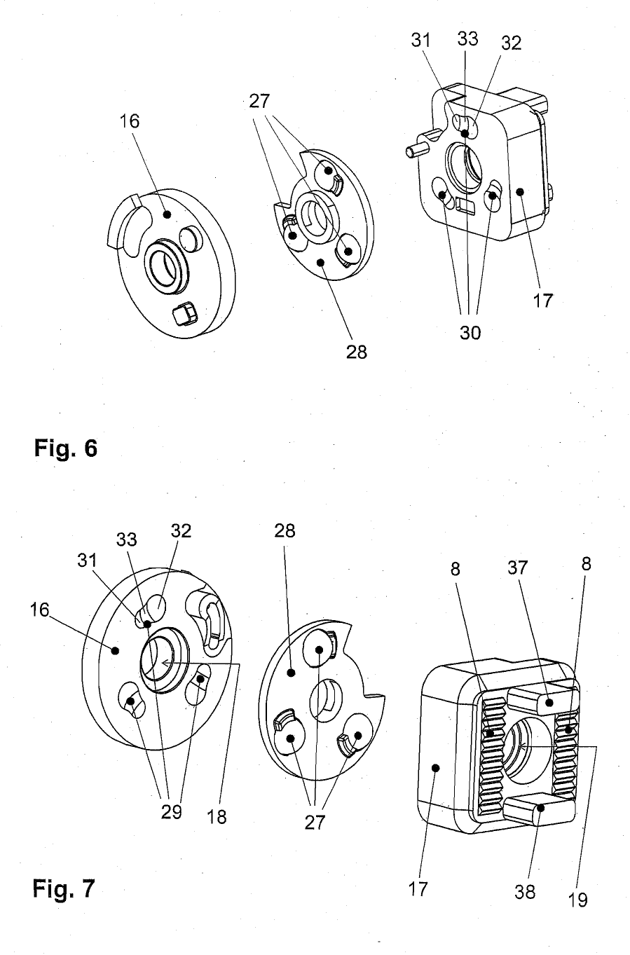

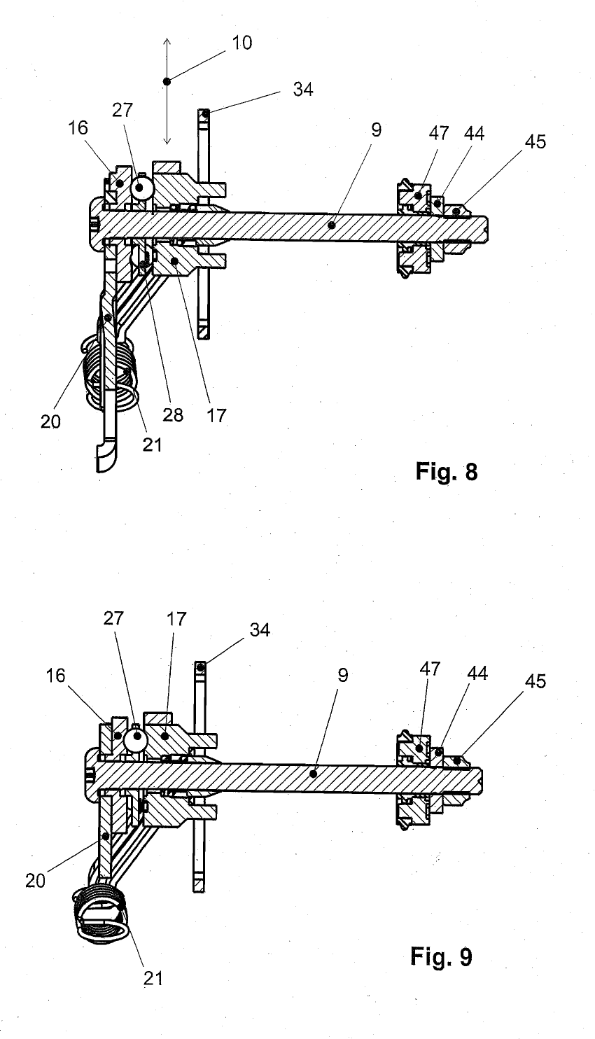

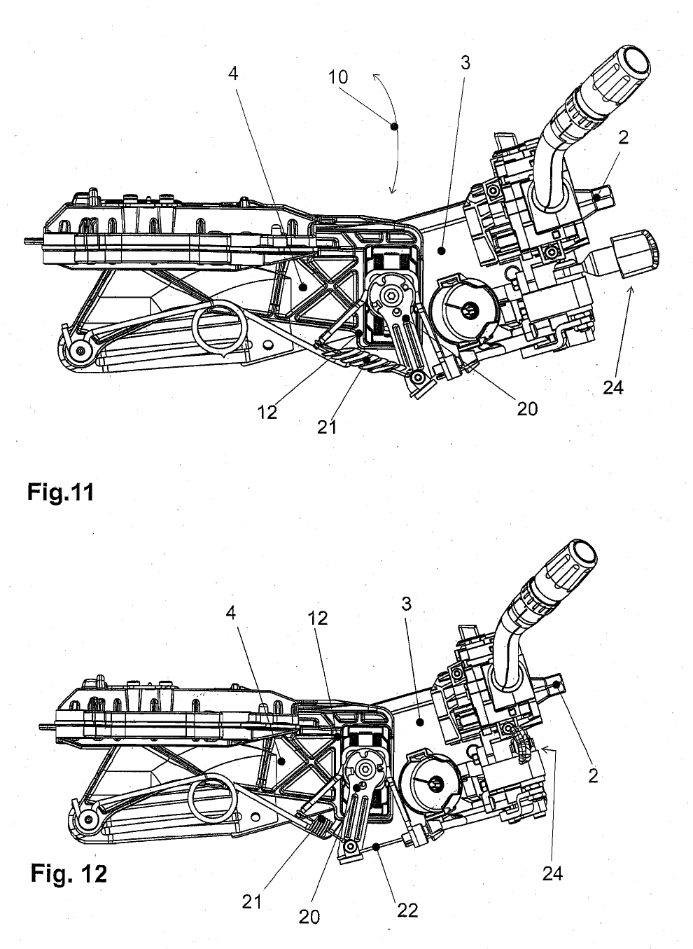

An advantageous embodiment of the invention is shown in FIGS. 1 to 12. In FIG. 1 the section adjoining the steering wheel, of the steering column is shown together with the steering wheel 1. The steering column comprises a steering spindle 2 turnable by rotating the steering wheel 1, of which a section adjoining the steering wheel 1 is rotatably supported in a jacket unit 3. The further sections of the steering spindle 2 adjoining in the direction toward the steering gearing are not shown in the Figures. Two or more such sections are connected with one another in conventional manner via universal joints.

The steering column comprises further a support unit 4 which is connected with the chassis of the motor vehicle.

The steering column is at least adjustable in terms of inclination, which leads to a height adjustment of the steering column in the configuration conventional in passenger cars. For this purpose the jacket unit 3 can be swivelled about a swivel axis 5 with respect to the support unit 4, which axis is transverse to the steering spindle 2.

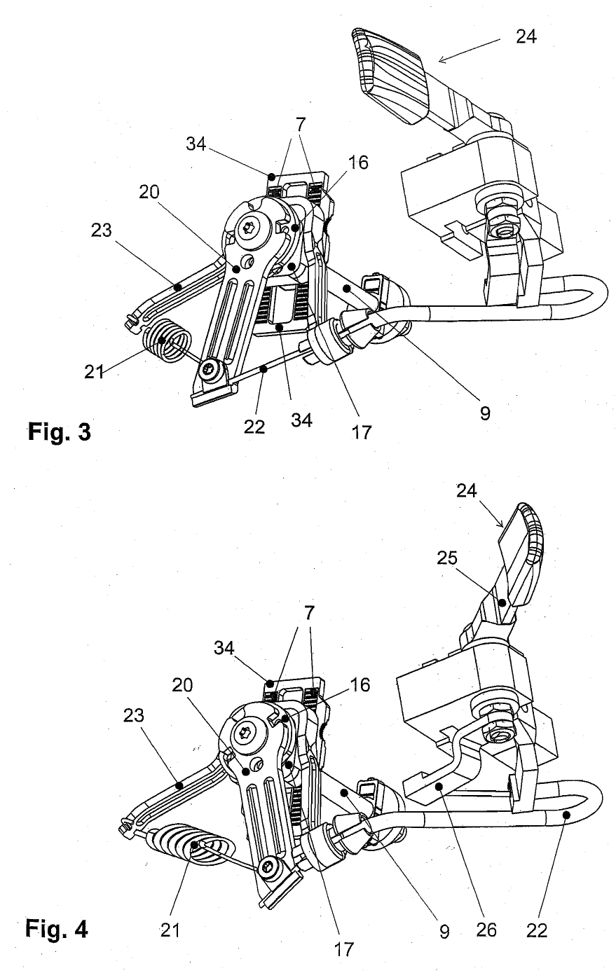

To fix the set swivel position of the jacket unit 3 with respect to the support unit 4, a clamping mechanism 6 is provided. In the closed state of the clamping mechanism 6, toothings 7, 8 (cf. for example FIGS. 3, 4 and 7) are in engagement with one another. The parts comprising the toothings 7, 8 form securement elements for fixing the set position of the steering column.

The clamping mechanism 6 comprises a clamp bolt 9 penetrating the jacket unit 3 and the support unit 4 through openings and being transverse to the axis of the steering spindle 2.

The toothings 7, 8 extend in planes at right angles to the longitudinal axis of the clamp bolt 9. These planes are parallel to the planes in which side shanks 12, 13 of the support unit 4 are disposed and between which the jacket unit 3 is located.

The openings 11 of the support unit 4 are disposed in the side shanks 12, 13 of the support unit 4, between which the jacket unit 3 is located. These openings 11 are formed in the shape of elongated holes which, at least approximately, extend in an adjustment direction 10 of the steering column corresponding to the inclination or height adjustment.

In the depicted embodiment example, in which the steering column is only adjustable in inclination, the opening in the jacket unit 3 can be formed as a passage opening with round cross section. In particular if an additional length adjustment of the steering column is desired, this opening can be formed as an elongated hole opening extending in the axial direction of the steering spindle 2. In this case, furthermore, the pins 14, 15 forming the swivel axis 5 can also extend through elongated holes in the jacket unit 3 in order to permit the longitudinal shifting of the jacket unit 3. It would also be conceivable and feasible to provide an additional guide unit, with respect to which the jacket unit 3 is shiftable in the longitudinal direction of the steering spindle 2 and which is swivellably connected with the support unit 4. Such types of design are known.

The clamping mechanism 6 comprises further a first and a second clamp member 16, 17 disposed on the clamp bolt 9, wherein the clamp bolt 9 penetrates openings 18, 19 in the first and second clamp member 16, 17. The second clamp member 17 is secured against turning with respect to the support unit 4. For opening and closing the clamping mechanism 6 the first clamp member 16 is turnable with respect to the second clamp member 17. For this purpose in the embodiment example according to FIGS. 1 to 9 a clamp lever 20 is connected with the first clamp member 16. Onto this clamp lever 20 acts, on the one hand, a tension spring 21, on the other hand, a Bowden cable 22. The tension spring 21 in the depicted embodiment example, is formed as a helical spring and is fastened with its one end on clamp lever 20 and with its other end on a holding bracket 23 disposed on the second clamp member 17 and with a second arm also holds the end piece of the flexible tube of the Bowden cable 22. The Bowden cable 22 leads to an actuation element 24 for the clamping mechanism, which is here implemented in the form of an actuation lever. Through an appropriate selection of the lever arms 25, 26 of actuation element 24 and of the lever arm of the clamp lever 20 the actuation force acting onto the actuation element 24 can be transmitted correspondingly in order for the force or the actuation path for opening the clamping mechanism 6 to be adapted correspondingly.

Between the first and the second clamp member 16, 17 are disposed rolling bodies 27 which, in the depicted embodiment example, are formed in the shape of balls. The rolling bodies 27 are held rotatably in a cage 28 and with the turning of the first clamp member 16 with respect to the second clamp member 17, each roll out along raceways 29, 30 of the first and second clamp member 16, 17. The raceways 29, 30 comprise each a start section 31, located deeper, a higher located end section 32 and an interspaced ramp section (oblique face) 33.

An advantageous further development of the invention can provide that one or both of the raceways 29, 30 are implemented such that they monotonically increase over their entire course or monotonically decrease. Monotonically increasing or monotonically decreasing means that over the entire length of the particular raceway 29, 30 only one direction of inclination is provided and that thus neither increasing and decreasing section alternate nor sections are available, which, with respect to the axial direction of the clamp bolt 9, extend at a constant level. This monotonic course can therein also be progressive or regressive. In cooperation with the tension spring 21 in this way the acting clamp force can be set. This becomes possible since in the configuration according to the invention no “snapping in” of the actuation element 24 is necessary. The necessary turn angle between the two positions of the clamp lever 20 for the opened position and the closed position can thereby be decreased.

In the closed position depicted in FIGS. 3, 8 and 12 of the first clamp member 16 the rolling bodies 27 are located in the deeper start sections 31 of raceways 29, 30. When the first clamp member 16 is rotated into its closed position, the rolling bodies 27 roll out over the ramp sections 33 into the raised end sections 32 of the raceways 29, 30, whereby the distance between the clamp members 16, 17 is slightly increased and the clamping mechanism assumes a closed or clamped state.

It would also be feasible that only one of the two clamp members 16, 17 comprises raceways with ramp sections 33.

In the depicted embodiment example the toothing 7 is disposed on a toothed plate 34, which is disposed on the side shank 12 of the support unit 4. The toothing could also be formed directly on the side shank 12 of the support unit.

In the depicted embodiment example the toothing 8 cooperating with toothing 7 is formed on the side face of the second clamp member 17 facing away from the first clamp member 16. It would also be conceivable and feasible that this toothing is formed on a separate part disposed between the second clamp member 17 and the side shank 12.

A spring 35 serves for spacing apart the toothing 8 from the toothing 7 in the opened state of the clamping mechanism 6 and for this purpose lies, on the one hand, on the second clamp member 17, on the other hand, via a sliding sleeve 36 on the toothed plate 34 or on the side shank 12.

To secure the second clamp member 17 against turning with respect to the support unit 4, this member includes extensions 37, 38, which project into the opening of the toothed plate 34 or into the opening 11 of the side shank 12 of the support unit 4.

The first clamp member 16 or the clamp lever 20 disposed thereon is stayed in the axial direction of the clamp bolt 9 on an end piece 43 of clamp bolt 9, which is implemented in the form of an enlarged head of the clamp bolt.

At the opposing end of clamp bolt 9 an end piece 45 is disposed in the form of a nut. On this piece is stayed in the axial direction of the clamp bolt 9, with the interspacing of a washer or of an axial bearing 44, a counterpressure plate 46, which is disposed on the clamp bolt 9 and in the closed state of the clamping mechanism 6 is pressed onto the side shank 13 of the support unit 4. With the counterpressure plate is furthermore connected a stop absorber 47.

The counterpressure plate 46 could also include a toothing which cooperates with a toothing on the side shank 13 or on a toothed plate disposed on side shank 13. It would also be feasible to provide only on this side of the jacket unit 3 toothings cooperating with one another.

In order to adjust the inclination of the steering column, by swivelling the actuation element 24 the clamp lever 20 is swivelled against the force of the tension spring 21 about the axis of the clamp bolt 9, whereby the first clamp member 16 is rotated into its open position in which the toothings 7, 8 are out of engagement. After the desired adjustment of the steering column, the actuation element 24 is released, whereupon the clamping mechanism 6 is tightened through the tension spring 21 and the side shanks 12, 13 are pressed on both side onto the jacket unit 3.

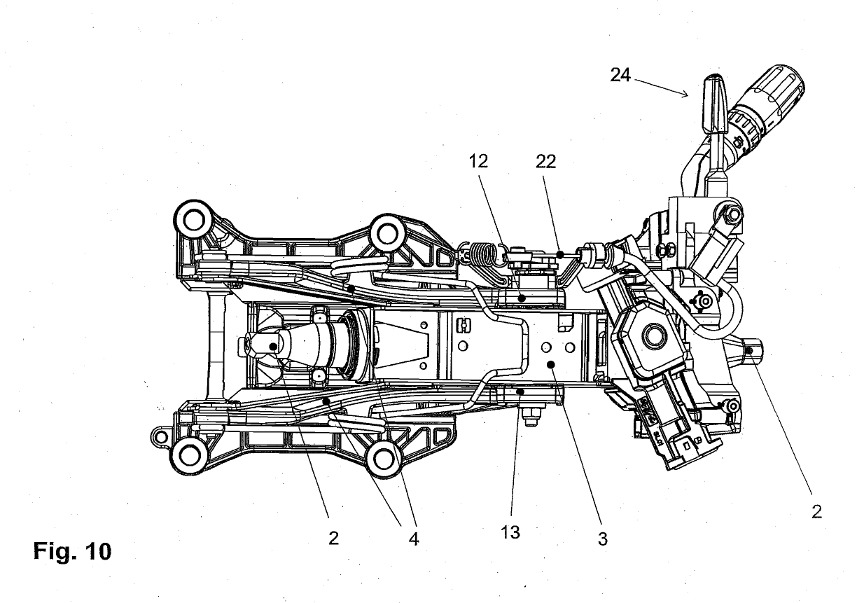

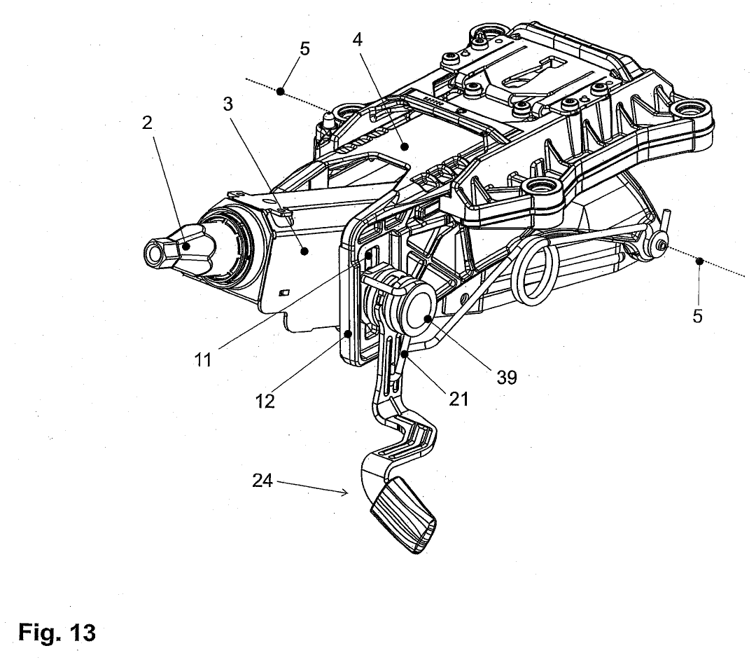

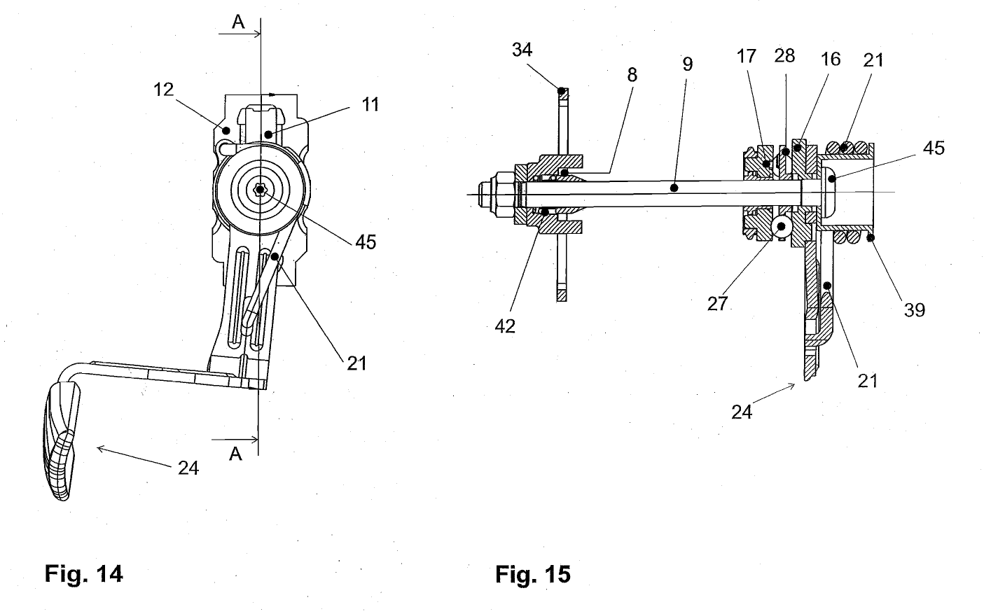

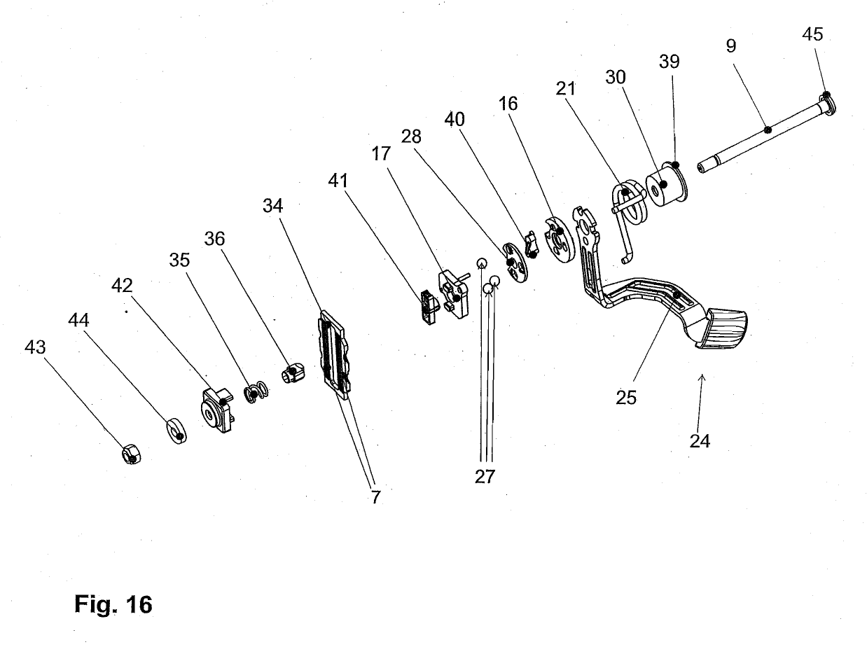

The embodiment example depicted in FIGS. 9 to 16 differs from the previously described embodiment example primarily thereby that the actuation element 24, which is again formed as an actuation lever, is here directly disposed on the first clamp member 16. The tension spring 21 acts between the actuation element 24 and the second clamp member 17 and is preferably disposed on a spring seat 39 disposed on the clamp bolt 9.

Between the first clamp member 16 and the second clamp member 17 acts advantageously a radial stop absorber 40. Between the second clamp member 17 and the side shank 13 an axial stop absorber 41 is disposed.

The toothing 7, connected with the support unit 4 such that it is nonshiftable in the adjustment direction 10, is again disposed on a toothed plate 34 which is fastened on one of the side shanks 13 of support unit 4. The toothing 8 cooperating with this toothing is formed on a further toothed plate 42 disposed on the clamp bolt 9. Between the toothed plates 34, 42 acts again a spring 35 with a sliding sleeve 36. The toothed plate 42 is stayed on an end piece 43 formed by a nut of the clamp bolt 9 via a washer or an axial bearing 44. The spring seat 39 is stayed on the opposite end piece 45 of the clamp bolt 9, which is formed by a head of the clamp bolt. To open the clamping mechanism, the first clamp member 16 is turned by means of the actuation element 24 against the force of tension spring 21, whereupon the clamping of the jacket unit 3 with the support unit 4 is cancelled and the toothings 7, 8 are brought out of engagement. After setting the desired inclination position of the steering column, the actuation element 24 is released, whereupon the tension spring 21 turns the first clamp member 16 into its closed position in which the jacket unit 3 is clamped with the support unit 4 and the toothings 7, 8 are in engagement with one another.

The problem is solved in strikingly simple manner with the solution according to the invention and entails a number of further advantages.

In both depicted embodiments the clamping of the support unit 4 with the jacket unit 3 and the engaged toothings 7, 8 ensures high rigidity and good reduction of the vibrations. Due to the clamping, the toothings 7, 8 can be implemented correspondingly in fine steps such that the steering column can be positioned precisely.

In the embodiment example the invention is explained in conjunction with long-tilt steering columns. Long-tilt steering columns are also characterized in that the distance between the steering wheel and the center of rotation of the swivelling is long in comparison to the head-tilt steering columns. As a consequence, in each position of the adjustment of the steering column the rotational axis in the long-tilt is oriented toward the driver, while the rotational axis in the head-tilt is strongly swivelled and is not oriented toward the driver in every position.

The application of the invention is to be especially preferred for long-tilt steering systems. Through the comparatively large distance between clamping system and center of rotation high torques for fixing the setting part with respect to the holding part are already exerted with low spring forces such that high rigidities are attained. The use of the arrangement according to the invention, however, is in principle also feasible in head-tilt steering columns. However, the spring force of the tension spring must be increased in order to attain the high rigidity corresponding to the demands.

Through the self-acting clamping and the actuation force on the actuation element 24 reduced by a lever transmission system, high ease of use is attained.

Instead of the transmission of the lever arm with a simple lever or Bowden cable depicted in the embodiment examples, a multi-membered mechanism with, for example, push rods, pull rods, cable pulls, deflection gearing and/or other intermediate members can also be utilized.

Instead of the depicted spherical rolling bodies 27, for example, cylindrical rolling bodies can also be utilized. These can be supported rotatably about rotational axes of the cage 28.

In the depicted embodiment examples three rolling bodies 27 with the corresponding number of raceways 29, 30 are shown. It would also be conceivable and feasible to use a larger number of rolling bodies 27 and associated raceways 29, 30.

In the depicted embodiment examples, furthermore, fixing under positive locking of the inclination adjustment of the steering column is shown. Fixing of the height adjustment under frictional locking would also be conceivable and feasible.

In addition to the depicted inclination adjustment, the steering columns can also be implemented such that they are length adjustable, with the fixing of the length adjustment taking place under positive locking, in particular by means of cooperating toothings, or under frictional locking, and is also brought about preferably by means of the same clamping mechanism through the tension spring 21.

In an especially advantageous manner a single tension spring 21 suffices for this purpose. Furthermore, the clamping of the steering column in the length and inclination direction takes place in a common areal region.

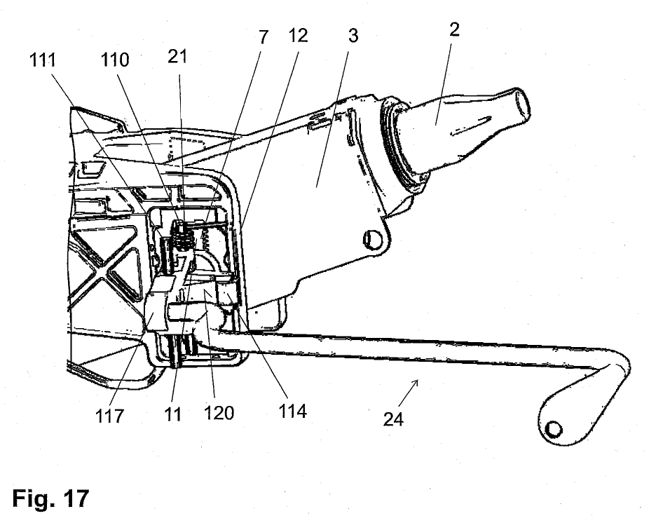

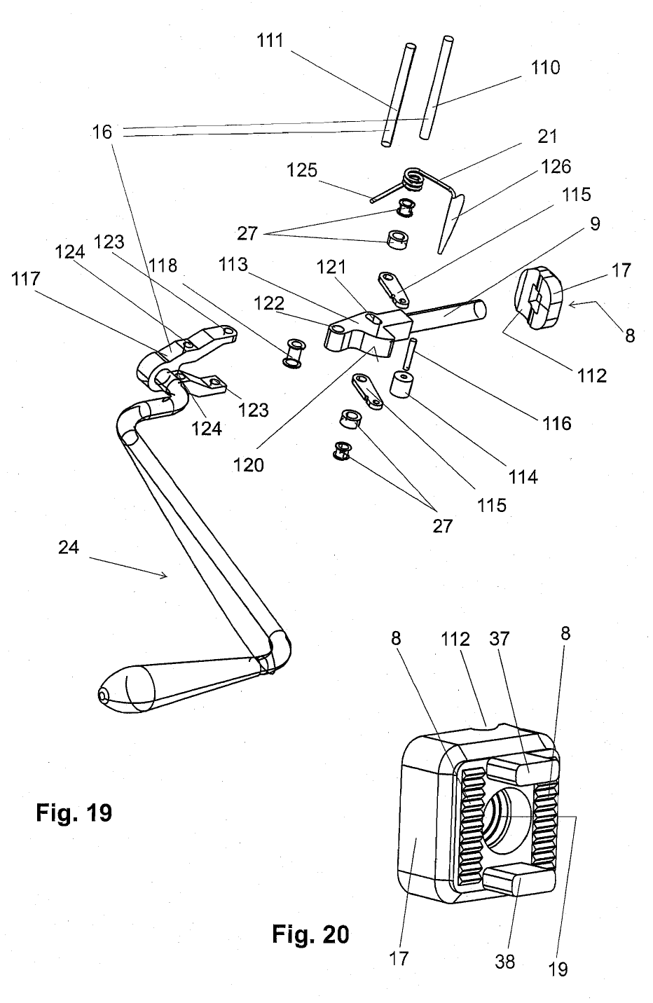

A further embodiment example of the invention is depicted in FIGS. 17 to 20. The steering column is, for example, again depicted as adjustable in height or inclination. For the securement of the set position in the closed state of a clamping mechanism 6 serve again meshing toothings 7, 8 disposed transversely to the axis of the clamp bolt 9. The parts located on the one side of the steering spindle of the clamping mechanism are in particular evident in the exploded representation according to FIG. 19. The parts on the other side of the steering spindle can be implemented analogously to the previously described embodiments.

At the end side on the clamp bolt 9 a head piece 113 is disposed which comprises passage openings 121, 122 extending at right angles to the axis of the clamp bolt 9. The passage opening 121 is penetrated by a first bolt 110, the passage opening 122 by a second bolt 111. Bolts 110, 111 penetrate further bores 123, 124 in the two fork extensions of a fork 117. Since the first bolt 110 penetrates the passage opening 121 with play or this passage opening 121 is implemented in the form of an elongated hole, swivelling of the fork 117 with respect to the head piece 113 about the bolt 111 is limited. The swivelling takes place by means of an actuation element 24 formed by a lever. Into the passage opening 122 is set a sleeve 118 receiving the second bolt 111.

On the first bolt 110 are rotatably supported rolling bodies 27, which, for example as shown, can each be implemented in two parts, with a hub and a crown disposed thereon. The rolling bodies 27 cooperate with the second clamp member 17.

On the first bolt 110 are furthermore disposed arms 115 on both sides of the head piece 113, which arms support an axle 116 in end sections remote from the first bolt 110 (which axle engages into bores in arms 115). On this axle 116 is pivoted a rolling body 114, which cooperates with a guide face 120 of the head piece 113.

Disposed on the first bolt 110 is furthermore a tension spring 21, of which one leg 125 is in contact on the second bolt 111 and the other leg 126 on the side shank 12 of support unit 4.

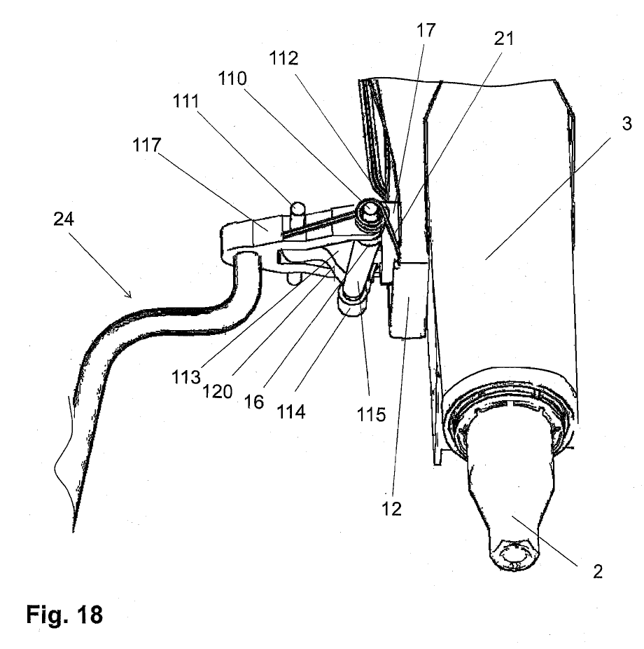

When the actuation element 24 is released, the clamping mechanism 6 is brought by the tension spring 21 into its closed state, which is depicted in FIGS. 17 and 18. To open the clamping mechanism, the fork 117 with the bolts 110, 111 is swivelled about the axis of the first bolt 110, which axis is at right angles to clamp bolt 9, against the force of the tension spring 21. Fork 117 with bolts 110, 111 forms in this embodiment a first clamp member 16. Through this swivel the rolling bodies are moved further in the direction of a deepest region of a groove 112 which is provided in the side face facing the first clamp member 16, of the second clamp member 17. The toothing 8 of the second clamp member 17 is therein brought out of engagement with toothing 7 disposed on a toothed plate held on side shank 12.

When the actuation element 24 is released, the first clamp member 116 is swivelled back by the tension spring 21, with the rolling bodies 27 running against the wall of groove 112 in its rising region whereby the second clamp member 17 is pressed against the side shank 12. The toothings 8, 7 are therein brought into engagement. The side shank 12 is furthermore pressed against the jacket unit 3. Herein, furthermore, a tensile stress is applied onto the clamp bolt 9, whereby on the opposite side a side shank 13 is also pressed against the jacket unit 3.

The rolling body 114 serves for guiding the movement with respect to the head piece 113 on a guide face 120. This rolling body could optionally (together with the parts 115, 116 supporting it) also be omitted, wherein, for example, the passage opening 121 could be formed for the guidance of the movement of the first bolt 110.

In this embodiment the steering column could instead, or additionally, also be length adjustable.

As is evident in the above description, the scope of the invention is not limited to the depicted embodiment examples but rather should be determined with reference to the enclosed claims together with their full range of feasible equivalents. While the preceding description and the drawing represent the invention, it is obvious to a person of skill in the art that various modifications can be carried out therein without leaving the true spirt and scope of the invention.

### LEGEND TO THE REFERENCE NUMBERS

1 Steering wheel
2 Steering spindle
3 Jacket unit
4 Support unit
5 Swivel axis
6 Clamping mechanism
7 Toothing
8 Toothing
9 Clamp bolt
10 Adjustment direction
11 Opening
12 Side shank
13 Side shank
14 Pin
15 Pin
16 First clamp member
17 Second clamp member
18 Opening
19 Opening
20 Clamp lever
21 Tension spring
22 Bowden cable
23 Holding bracket
24 Actuation element
25 Lever arm
26 Lever arm
27 Rolling bodies
28 Cage
29 Raceway
30 Raceway
31 Start section
32 End section
33 Ramp section
34 Toothed plate
35 Spring
36 Sliding sleeve
37 Extension
38 Extension
39 Spring seat
40 Stop absorber
41 Stop absorber
42 Toothed plate
43 End piece
44 Axial bearing
45 End piece
46 Counter pressure plate
47 Stop absorber
110 First bolt
111 Second bolt
112 Groove
113 Head piece
114 Rolling body
115 Arm
116 Axle
117 Fork
118 Sleeve
120 Guide face
121 Passage opening
122 Passage opening
123 Bore
124 Bore
125 Leg
126 Leg

What is claimed is:

1. A steering column for a motor vehicle which is adjustable in at least one adjustment direction, comprising:
a rotatably supported steering spindle;
a jacket unit rotatably supporting a section of the steering spindle;
a support unit to be connected to the chassis of the motor vehicle and being displaceable in the at least one adjustment direction with respect to the jacket unit; and
a clamping mechanism, having an opened state in which the position of the steering column is adjustable and a closed state in which the position of the steering column is secured in position and in which the jacket unit is clamped with the support unit, said clamping mechanism comprising:
a clamp bolt penetrating through openings in the jacket unit and the support unit transversely to the axis of the steering spindle, on said clamp bolt a part with a toothing being disposed; and
first and second clamp members disposed on the clamp bolt, said first clamp member being operable to open and close the clamping mechanism and being turnable with respect to the second clamp member between an open position and a closed position about the axis of the clamp bolt or about an axis at right angles to the axis of the clamp bolt, and between which rolling bodies for friction reduction during the mutual turning are disposed,
wherein the first clamp member is acted upon by a tension spring into its closed position, and is turnable through an actuation force exerted onto an actuation element against the force of the tension spring from its closed position into its open position and the tension spring upon termination of the actuating force acting onto the actuation element turns the first clamp member from its open position into its closed position, and
for the securement in position of the adjustment of the steering column in at least one adjustment direction, the toothing of said part on the clamp bolt meshes with a toothing of the support unit in the closed state of the clamping mechanism.

2. The steering column as claimed in claim 1, wherein said support unit includes a side shank and said toothing of the support unit is on said side shank.

3. The steering column as claimed in claim 1, wherein said support unit includes a side shank, and a toothed plate on said side shank, and said toothing of the support unit is on said toothed plate.

4. The steering column as claimed in claim 1, wherein the support unit includes side shanks between which the jacket unit is disposed and which in the closed state of the clamping mechanism are pressed on both sides onto the jacket unit.

5. The steering column as claimed in claim 1, wherein the second clamp member is the part disposed on the clamp bolt which includes the toothing.

6. The steering column as claimed in claim 1, wherein a toothed plate is disposed on the clamp bolt and includes the toothing.

7. The steering column as claimed in claim 1, wherein the actuation force exerted onto the actuation element for swivelling the first clamp member is mechanically transmitted.

8. The steering column as claimed in claim 7, wherein the actuation force exerted onto the actuation element is transferred via a Bowden cable onto the first clamp member.

9. The steering column as claimed in claim 8, wherein the actuation element is an actuation lever on which the Bowden cable is engaged.

10. The steering column as claimed in claim 8, comprising a further clamp member connected with the first clamp member, wherein said further clamp member engages the tension spring and the Bowden cable.

11. The steering column as claimed in claim 1, wherein the actuation element is an actuation lever disposed on the first clamp member.

12. The steering column as claimed in claim 1, wherein the first clamp member and the second clamp member include raceways along which rolling bodies roll out during the opening and closing of the clamping mechanism, and the raceways of at least one of the first and second clamp members comprise ramp sections between a start section and an end sections which are at different levels with respect to the axial direction of the clamp bolt.

13. The steering column as claimed in claim 1, wherein the first clamp member and the second clamp member include raceways along which rolling bodies roll out during the opening and closing of the clamping mechanism, and the raceways of at least one of the first and second clamp members have a monotonically increasing or a monotonically decreasing course over their entire length.

14. The steering column as claimed in claim 1, wherein rolling bodies are rotatably supported in a cage disposed between the first and the second clamp members.

15. The steering column as claimed in claim 1, wherein the steering column is at least adjustable in its inclination and the jacket unit for the adjustment of the inclination of the steering column is swivellable about a swivel axis with respect to the support unit.
